(19) United States
(12) Patent Application Publication
(10) Pub. No.: US 2023/0137336 A1
(43) Pub. Date: May 4, 2023

(54) System and Method for Allowing Real Estate Agents to Identify Open House Opportunities

(71) Applicant: Yvonne Oriaku, Washington, WA (US)

(72) Inventor: Yvonne Oriaku, Washington, WA (US)

(21) Appl. No.: 17/513,507

(22) Filed: Oct. 28, 2021

(51) Int. Cl. G06Q 50/16

(52) U.S. Cl. CPC G06Q 50/163

(57) ABSTRACT

A method for allowing real estate agents to identify open house opportunities comprising configuring, at least one user device; receiving data. A processor component is configured to: pull a plurality of active real estate listings; create a filter to break up the licensed real estate agents into pools associated with their brokerage affiliations; assign each listing by brokerage; identify the licensed real estate agents for each listing; notify listing agents; match the plurality of active real estate listings; display the selected dates and times to the listing agents; allow each of the hosting agents and the listing agents affiliated within the same brokerage as the listing agents to submit request for hosting an open house slot; and allow the licensed real estate agents to hire other licensed real estate agents based on calendar availability or location to host each open house slot and complete licensed real estate activities.

### BACKGROUND

### Field of Invention

The present invention relates generally to the field of real estate open houses. More particularly, the present invention is related to the management of real estate open house data for allowing real estate agents to identify the open house hosting opportunities, schedule and communicate open house opportunities to other real estate agents, and for real estate brokers to display in-depth open house hosting details to other agents and to the public within a single platform

### Description of Related Art

Real estate companies and brokerages list and sell properties with a sales force of individual real estate agents who make up the brokerage. A public open house is the act of displaying a property to members of the public by licensed real estate agents, while a broker's open house is meant to help brokers determine whether the house would be of interest to their clients. The real estate agents may notify their network of industry connections once a broker's open house is scheduled.

The real estate agent that tours a home during a broker's open house examines whether the property is a good fit for any of their clients, and if so, they may bring those clients to the property for a private showing within the next few days, especially if the broker's open house is heavily attended. Traditionally, property owners list their homes with one or more listing brokerages, with each brokerage permitting only its own agents to promote their homes and to show the homes to the public through a public open house. In a public open house, consumers who tour the home may do so with or without their real estate agent and may decide to purchase the home after viewing it during the public open house.

Traditional open house data collection methods are inefficient and unreliable. Traditional open house opportunities systems and methods in process have the disadvantage of being time consuming, prone to errors and allowing only certain agents to market the properties. Further, the traditional methods are not time-reliant, and do not publicize the details of the open house, including the name of the hosting agency, and do not display hosting agent information for the open house. The listing agent of a property does not always have to host the open house, members of the same brokerage may collaborate and leverage each other's licenses to host open houses on behalf of other listing agents provided that both agents are members of the brokerage.

Additionally, to improve the dependability of smoothly creating, planning, and identifying open houses, an effective solution for using an open house opportunities identification system and method is still required.

### SUMMARY

Embodiments in accordance with the present invention provide a method for allowing real estate agents to identify open house opportunities. The method includes configuring, at least one user device for registering at least one user. The at least one user device may be communicably coupled with a communication network for creating a user account using a web-based platform installed on the at least one user device. The method also includes receiving, data associated with the at least one user on a storage arrangement when the registration is completed. Data being processed by a processor component may be configured on the storage arrangement. The processor component is configured to pull a plurality of active real estate listings from the storage arrangement for processing. The processor component is also configured to assign each listing by brokerage to ensure that the filter remain in place and the licensed real estate agents view open houses within their specific brokerage. The processor component is also configured to identify the licensed real estate listing agents for each listing. The processor component is further configured to notify listing agents and prompts the listing agent to authenticate ownership of the listing. The processor component is configured to match the plurality of active real estate listings to the listing agent using a unique identifier, when the listing agent is confirmed within the web-based platform installed on the at least one user device, the listing agent is allowed to make and schedule the listing available on selected dates and times for hosting an open house. The processor component is configured to display the selected dates and times to the listing agents and a plurality of hosting agents affiliated within the same brokerage as the listing agent on a user interface of the at least one user device. The processor component is configured to allow each of the hosting agents and the listing agents affiliated within the same brokerage as the listing agents to submit request for hosting an open house slot at the listing on behalf of the listing agent on selected dates and times. The processor component is configured to allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform installed on the at least one user device.

In one embodiment of the present invention, data comprises open house details, agent hosting an open house, photographs, a name, a contact number, an email, a biography, hosting agent details, listing agent details, and/or foregoing combination.

In one embodiment of the present invention, the filter comprises a “Chinese wall” barrier. Further, the filter is configured to break up the licensed real estate agents into pools associated with their credentials.

Embodiments in accordance with the present invention provide an open house opportunities identifying. The system includes at least one user device configured for at least one user registration. The system also includes a communication network configured to communicate with the at least one user device for creating a user account using a web-based platform installed on the at least one user device. The system also includes a storage arrangement configured to receive data associated with the at least one user, when the registration of the at least one user is completed. The system also includes processor component configured on the storage arrangement for processing the data. The processor component is configured to pull a plurality of active real estate listings from the storage arrangement for processing. The processor component is configured to assign each listing by brokerage to ensure that the filter remain in place and the licensed real estate agents view open houses within their specific brokerage. The processor component is configured to identify the licensed real estate agents for each listing. The processor component is configured to notify listing agents and prompts the listing agent to authenticate ownership of the listing. The processor component is configured to match the plurality of active real estate listings to the listing agent using a unique identifier, when the listing agent is confirmed within the web-based platform installed on the at least one user device, the listing agent is allowed to make and schedule the listing available on selected dates and times for hosting an open house. The processor component is configured to display the selected dates and times to the listing agents and a plurality of hosting agents affiliated within the same brokerage as the listing agent on a user interface of the at least one user device. The processor component is configured to allow each of the hosting agents and the listing agents affiliated within the same brokerage as the listing agents to submit request for hosting an open house slot at the listing on behalf of the listing agent on selected dates and times. The processor component is configured to allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform installed on the at least one user device.

Embodiments in accordance with the present invention provides accessing and scheduling open house opportunities for creating a compensation mechanism using the processor component between a buyer or the licensed real estate listing agent posting the open house opportunities and the licensed real estate agent hosting the open house opportunities.

Embodiments in accordance with the present invention provide a method for allowing real estate agents to identify Open House opportunities within a real estate brokerage, and hire other agents within the same broker or from affiliated or cooperating brokerages. Agents who need help with marketing their listings through open houses due to time or other constraints have the ability to make the listings available to the multitude of agents within their broker. This makes it very easy for agents within a brokerage to find each other's listings, help each other host open houses and keep a steady flow of revenue for the brokerage while keeping homeowners and seller happy.

The present invention allows agents to find help from within their brokerage using this proprietary technology that makes it impossible to violate real estate rules by hiring agents from competing brokers.

The object of the present invention is to ensure a broker's peace of mind that their agents are always acting in accordance with realtor regulations and guidelines when taking on activities on behalf of another agent.

The object of the present invention also allows real estate brokerages to provide information about open houses being hosted by their agents within one-platform. Allowing the public to access open house information and view details of agents who they may expect to meet should they attend the open house. This gives the public peace of mind and provides a most effective and efficient way to find open houses. A one-stop platform for multi-brokerage open house information sharing to the public.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a block diagram of an open house opportunities identification system, according to embodiments of the present invention disclosed herein;

FIG. 2 illustrates a flowchart of a method for allowing real estate agents to identify open house opportunities, according to embodiments of the present invention disclosed herein;

FIG. 3 illustrates a block diagram of agency choice settings for real estate agents to identify house opportunities, according to embodiments of the present invention disclosed herein;

FIG. 4 illustrates a process flow for accessing a web-based platform of the open house opportunities identification system, according to embodiments of the present invention disclosed herein;

FIG. 5 illustrates a process flow for hiring assistance using the open house opportunities identification system, according to embodiments of the present invention disclosed herein;

FIG. 6 illustrates a process flow for posting a job using the open house opportunities identification system, according to embodiments of the present invention disclosed herein;

FIG. 7 illustrate a process flow of the open house opportunities identification system, according to embodiments of the present invention disclosed herein; and

FIG. 8 illustrates a process flow of the payment involved in the open house opportunities identification system, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

Terms such as ‘connect’, ‘integrate’, ‘configure’, and other similar terms may include a physical connection, a wireless connection, a logical connection or a combination of such connections including electrical, optical, RF, infrared, or other transmission media, and include configuration of software applications to execute computer program instructions, as specific to the presently disclosed embodiments, or as may be obvious to a person skilled in the art.

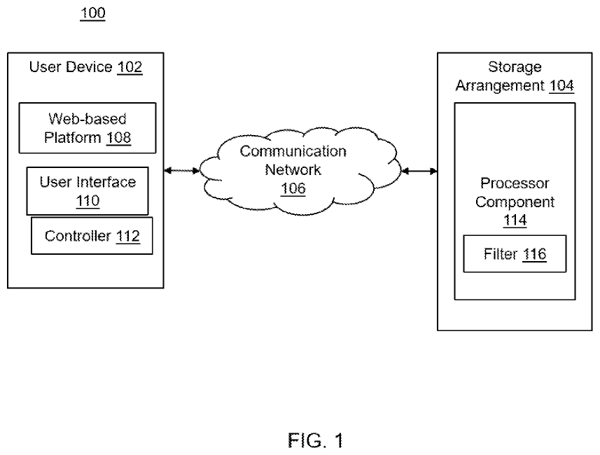

FIG. 1 illustrates a block diagram of an open house opportunities identification system 100, according to embodiments of the present invention. The system 100 comprises at least one user device 102, a storage arrangement 104, and a communication network 106, according to embodiments of the present invention. Further, the at least one user device 102 and the storage arrangement 104 may be connected through the communication network 106, according to embodiments of the present invention.

According to embodiments of the present invention, the communication network 106 may include a data network such as, but not limited to, an Internet, a Local Area Network (LAN), a Wide Area Network (WAN), a Metropolitan Area Network (MAN), and so forth. In some embodiments of the present invention, the communication network 106 may include a wireless network, such as, but not limited to, a cellular network and may employ various technologies including an Enhanced Data Rates for Global Evolution (EDGE), a General Packet Radio Service (GPRS), and so forth. In some embodiments of the present invention, the communication network 106 may include or otherwise cover networks or sub-networks, each of which may include, for example, a wired or a wireless data pathway. According to an embodiment of the present invention, the at least one user device 102 and the storage arrangement 104 may be configured to communicate with each other by one or more communication mediums connected to the communication network 106. The communication mediums include, but are not limited to, a coaxial cable, a copper wire, a fiber optic, a wire that comprise a system bus coupled to a processor of a computing device, and so forth. Embodiments of the present invention are intended to include or otherwise cover any type of the communication mediums, including known, related art, and/or later developed technologies.

According to an embodiment of the present invention, the least one user device 102 may be configured for registering at least one user. The user may be a hosting agent, a listing agent, a sales agent, a licensed real estate agent, a buyer, and so forth. In an embodiment of the present invention, the user device 102 may include a smart electronic device capable of communicating with various other electronic devices and applications via one or more communication networks. Examples of said user device 102 may include, but not limited to, a wireless communication device, a smart phone, a tablet, a desktop, a mobile device, a portable computer, a laptop computer, a smart device, a smart watch, a smart glass, and so forth. The user device 102 may comprise: an input unit to receive one or more input data; an operating system to enable the user device to operate; a processor to process various data and information; a memory unit to store initial data, intermediary data and final data; and an output unit. Embodiments are intended to include or otherwise cover any type of the user device 102, including known, related art, and/or later developed technologies. According to an embodiment of the present invention, the at least one user device 102 may be configured to enable a user to receive data and transmit data within the open house opportunities identification system 100.

Further, the at least one user device 102 may comprise a web-based platform 108, a user interface 110, a controller 112, and so forth. The web-based platform 108 accordingly aggregates priority information about the open house opportunities and provide to the users. The web-based platform 108 may be an application installed on the user device 102 for identifying the open house opportunities. The web-based platform 108 may be downloaded on the user device 102 for showing of a property for sale target to a user. The web-based platform 108 may be configured to enable agents to find and notify whether the property may be of interest to any of their clients. According to embodiments of the present invention, the communication network 106 may be configured to communicate with the at least one user device 102 for creating a user account using the web-based platform 108 installed on the at least one user device 102.

The user interface 110 may be configured to enable the user to input data into the open house opportunities identification system 100, according to an embodiment of the present invention. The user interface 110 may be further configured to display output data associated with the open house opportunities identification system 100, in an embodiment of the present invention. Further, the user interface 110 may be, but is not limited to, a digital display, a touch screen display, a graphical user interface, and so forth. Embodiments of the present invention are intended to include or otherwise cover any type of the user interface 110 including known, related art, and/or later developed technologies that may be capable of enabling the user to input data and to display an output data.

According to embodiments of the present invention, the controller 112 that may be configured to receive data associated with the open house opportunities identification system 100 using the communication network 106. Further, the controller 112 may be configured to receive, transmit and process data associated with the open house opportunities identification system 100, in an embodiment of the present invention. According to embodiments of the present invention, the controller 112 may be, but not limited to, a Programmable Logic Control unit (PLC), a microcontroller, a microprocessor, a computing device, a development board, and so forth. Embodiments of the present invention are intended to include or otherwise cover any type of the controller 112 including known, related art, and/or later developed technologies that may be capable of processing the received data. The controller 112 may be configured to communicated with the storage arrangement 104.

According to embodiments of the present invention, the storage arrangement 104 may be configured to receive data associated with the at least one user, when the registration of the at least one user is completed. The data comprises open house details, agent hosting an open house, photographs, a name, a contact number, an email, hosting agent details, listing agent details, and so forth. In an embodiment of the present invention, the storage arrangement 104 may include a dedicated space to accommodate a plurality of computer systems, storage devices, servers, routers, network switches and other associated devices or components that are necessary in the processes of a typical telecommunication network, such as transportation of network data traffic from a server to the consumer premise equipment. The storage arrangement 104 may be configured to provide a dynamic storage management for data storage. The storage arrangement 104 may further comprise a processor component 114 to process various data and information.

According to embodiments of the present invention, the processor component 114 may be configured on the storage arrangement 104 for processing data. The term processor component 114 may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system. Suitable processor component 114 may include, by way of example, both general and special purpose microprocessors.

The processor component 114 may be configured to pull a plurality of active real estate listings from the storage arrangement for processing. The processor component 114 may be configured to create a filter 116 for demarcating licensed real estate agents based on brokerage affiliations. The filter 116 may be further configured to break up the licensed real estate agents into pools associated with their brokerage affiliations. In an embodiment of the present invention, the filter 116 comprises a “Chinese wall” barrier. In another embodiment of the present invention, the filter 116 may be configured to break up the licensed real estate agents into pools associated with their credentials.

In preferred embodiments of the present invention, the pools formed of the licensed real estate agents being further utilized to create an intra-broker pool of licensed real estate agents to facilitate showings on a dynamic calendar. Moreover, when the intra-broker is available, the intra-broker pool may be matched to a plurality of parameters. The plurality of parameters may comprise geographic location, a state license possession, availability, and/or any foregoing combination.

The processor component 114 may be configured to assign each listing by brokerage to ensure that the filter 116 remain in place and the licensed real estate agents view open houses within their specific brokerage. The processor component 114 may be further configured to identify the licensed real estate agents for each listing. Each listing by brokerage may be assigned based on a proprietary broker ID. The licensed real estate agents identified within a broker have no visibility or contact ability to licensed real estate agents that are members of a competing brokerage.

The processor component 114 may be configured to notify listing agents and prompts the listing agent to authenticate ownership of the listing. The processor component 114 may be configured to match the plurality of active real estate listings to the listing agent using a unique identifier. The unique identifier may be known as a Multiple Listing Service (MLS) ID number. The listing agents may be notified through notifications sent to the listing agents based on availability and proximity to a showing.

When the listing agent is confirmed within the web-based platform 108 installed on the at least one user device 102, the listing agent is allowed to make the listing available on selected dates and times for hosting an open house. The listing agents may be notified through notifications sent to the listing agents based on availability and proximity to a showing.

The processor component 114 may be configured to display the selected dates and times to the listing agents and a plurality of hosting agents affiliated within the same brokerage as the listing agent on the user interface 110 of the at least one user device 102. The processor component 114 may be configured to allow each of the hosting agents and the listing agents affiliated within the same brokerage as the listing agents to submit request for hosting an open house slot at the listing on behalf of the listing agent on selected dates and times.

The processor component 114 may be configured to allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform 108 installed on the at least one user device 102. The activities comprise showings, attending home inspections, attending walkthroughs and other tasks.

The open house opportunities may be accessed and scheduled for creating a compensation mechanism using the processor component 114 between a buyer or the licensed real estate agent posting the open house opportunities and the licensed real estate agent hosting the open house opportunities.

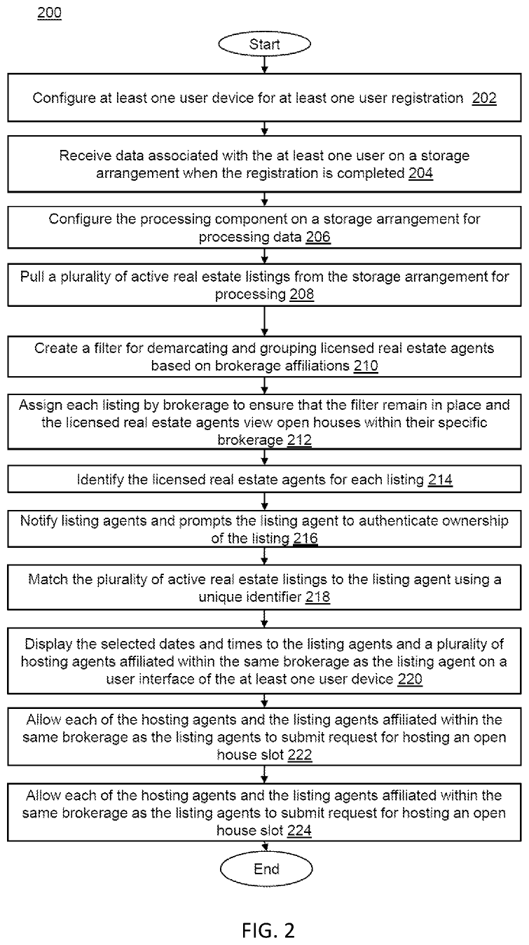

FIG. 2 illustrates a flowchart of a method 200 for allowing real estate agents to identify open house opportunities, according to embodiments of the present invention.

At 202, the open house opportunities identification system 100 may configure the at least one user device 102 for at least one user registration. The at least one user device 102 may be communicably coupled with a communication network 106 for creating a user account using a web-based platform 108 installed on the at least one user device 102.

At 204, the open house opportunities identification system 100 may receive data associated with the at least one user on the storage arrangement 104 when the registration is completed.

At 206, the open house opportunities identification system 100 may process data using the processor component 114 configured on the storage arrangement 104.

At 208, the open house opportunities identification system 100 may pull the plurality of active real estate listings from the storage arrangement 104 for processing using the processing component 114.

At 210, the open house opportunities identification system 100 may create a filter 116 for demarcating and grouping licensed real estate agents based on brokerage affiliations. The filter 116 may be configured to break up the licensed real estate agents into pools associated with their brokerage affiliations.

At 212, the open house opportunities identification system 100 may assign each listing by brokerage to ensure that the filter 116 remain in place and the licensed real estate agents view open houses within their specific brokerage.

At 214, the open house opportunities identification system 100 may identify the licensed real estate agents for each listing.

At 216, the open house opportunities identification system 100 may notify listing agents and prompts the listing agent to authenticate ownership of the listing.

At 218, the open house opportunities identification system 100 may match the plurality of active real estate listings to the listing agent using a unique identifier, when the listing agent is confirmed within the web-based platform installed on the at least one user device 192. Further, the listing agent may be allowed to make and schedule the listing available on selected dates and times for hosting an open house.

At 220, the open house opportunities identification system 100 may display the selected dates and times to the listing agents and a plurality of hosting agents affiliated within the same brokerage as the listing agent on the user interface 110 of the at least one user device 102.

At 222, the open house opportunities identification system 100 may allow each of the hosting agents and the listing agents affiliated within the same brokerage as the listing agents to submit request for hosting an open house slot at the listing on behalf of the listing agent on selected dates and times.

At 224, the open house opportunities identification system 100 may allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform 108 installed on the at least one user device 102.

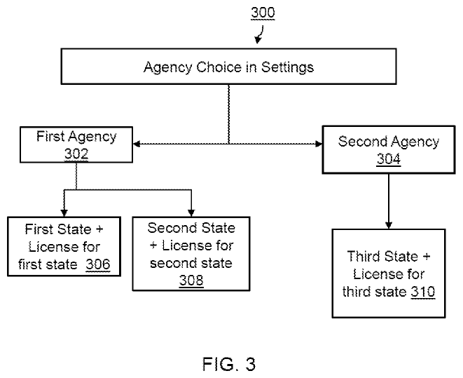

FIG. 3 illustrates a block diagram 300 of agency choice in settings for real estate agents to identify house opportunities, according to embodiments of the present invention. The agency choice in settings 300 may be present in the web-based platform 108 for choosing the agency by the agent. All the people from first agency 302 who may have license in first state 306 and second state 308 may be visible to the agent. Further, all the people from second agency 304 who may have license in third state 310 may be visible to the real estate agent.

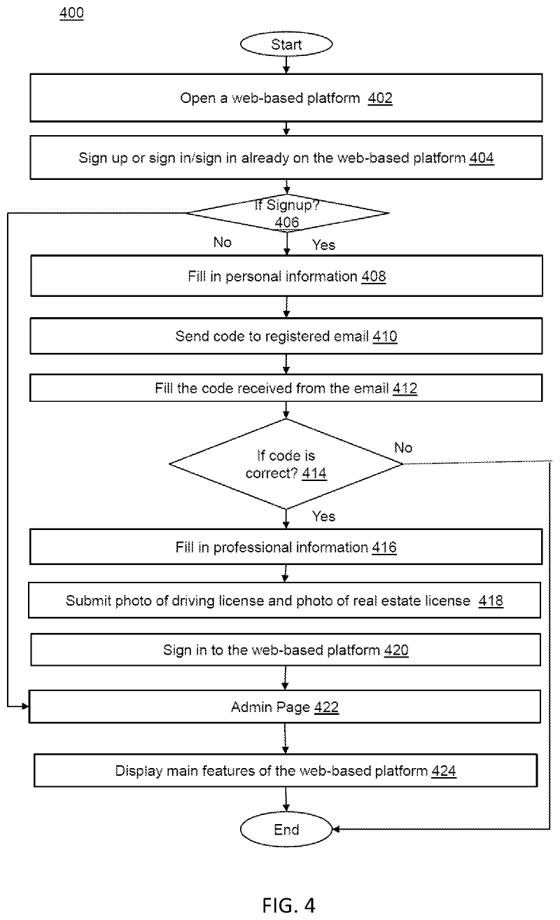

FIG. 4 illustrates a process flow 400 for accessing a web-based platform 108 of the open house opportunities identification system 100, according to embodiments of the present invention.

At 402, the user may open the web-based platform 108 installed on the user device 102.

At 404, the user may sign up, sign in, or choose the option of sign in already once the web-based application is opened.

At 406, if the user chooses “sign up” for creating a user account using the web-based platform 108 installed on the user device 102, then the open house opportunities identification system 100 moves at 408, otherwise at 424.

At 408, the open house opportunities identification system 100 may receive the personal information filled by the user. The personal information may comprise, a first name, a last name, a phone number, an email, and so forth.

At 410, the open house opportunities identification system 100 may send a code on the registered email.

At 412, the open house opportunities identification system 100 may fill in the code received from the email.

At 414, if the code is correct, the open house opportunities identification system 100 may move at 416, otherwise the process end.

At 416, the open house opportunities identification system 100 may fill in professional information. The professional information may comprise, a state information, a broker agency information, RE license ID, an MLS ID, and so forth.

At 418, the open house opportunities identification system 100 may submit a photo of driving license and a photo of RE license.

At 420, the open house opportunities identification system 100 may sign in the web-based platform 108.

At 422, the open house opportunities identification system 100 may direct the user to the admin page, once the user has successfully sign in.

At 424, the open house opportunities identification system 100 may display main features present on the web-based platform 108 installed on the user device 102.

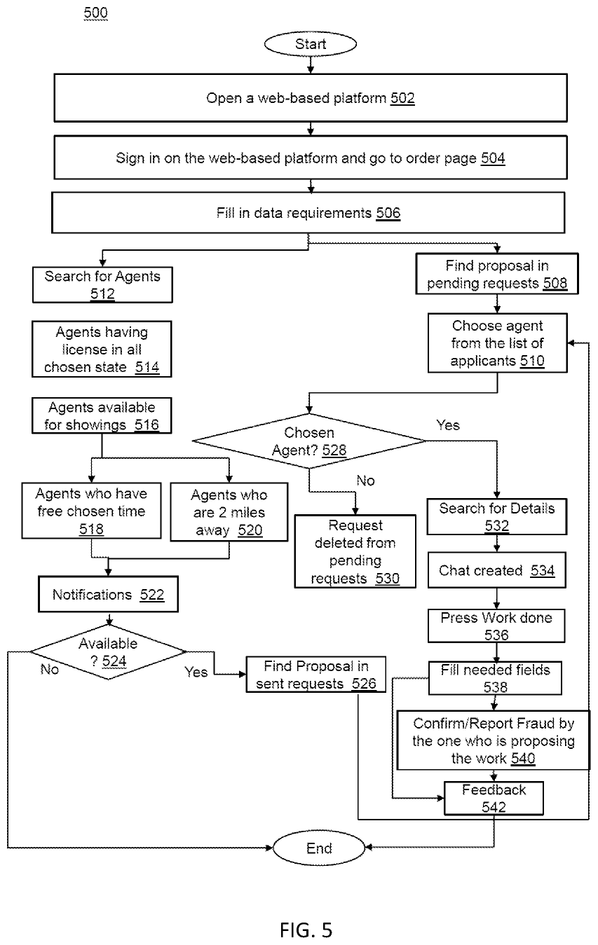

FIG. 5 illustrates a process flow 500 for hiring assistance using the open house opportunities identification system 100, according to embodiments of the present invention.

At 502, the user who may propose the work may open the web-based platform 108 installed on the user device 102.

At 504, the user who may propose the work may sign in on the web-based platform 108 installed on the user device 102 and go to order page.

At 506, the user who proposes the work may be allow the user to fill in data requirements. The data requirements may comprise, request, date, states, time, properties to show, duration, address, client information, and so forth.

At 508, the one who does the work may search for proposal in requests. The requests may be pending requests present on the one who has proposed the work.

At 510, the one who does the work may choose agent from the list of applicants.

At 512, the one who does the work may search for agents present in agency.

At 514, the one who does the work may search for agents having license in all chosen states.

At 516, the one who does the work may present the agents available for showing in web-based platform 108 settings.

At 518, the one who does the work may show the agents who have free chosen time.

At 520, the one who does the work may show the agents who are 2 miles away.

At 522, the one who does the work may show notifications to all the agents being filtered on process 518 and 520. The notification may receive the notification that expires in 5 mins, “are you available?”.

At 524, the one who does the work may check if the agent is available or not. If the agent is available the process moves at 526, otherwise the process ends.

At 526, the one who does the work may provide searching of the proposal in sent requests, and the process goes to the 510.

At 528, the open house opportunities identification system 100 may check if the agent is chosen or not. If the agent is chosen the process moves to step 532, otherwise the process moves to step 530.

At 530, the request may be deleted from the pending requests by the open house opportunities identification system 100.

At 532, the one who does the work may search for details.

At 534, the one who does the work may create chat, and the chat is created the process is moved to step 536.

At 536, the one who does work may press the work done.

At 538, the one who does the work may provide the fields to be filled.

At 540, the user who does the work may Confirm/Report Fraud by the one who is proposing the work.

At 542, the one who does the work and the one who proposes the work may provide an interface to the agents to provide feedback.

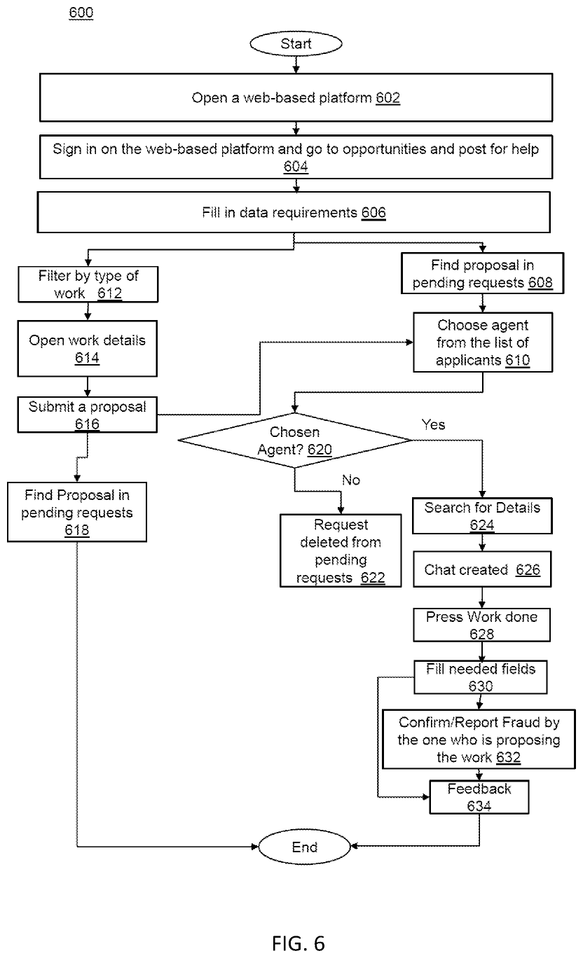

FIG. 6 illustrates a process flow 600 for posting a job using the open house opportunities identification system, according to embodiments of the present invention.

At 602, the user who proposes the work may open the web-based platform 108 installed on the user device 102.

At 604, the user who proposes the work may sign in on the web-based platform 108 installed on the user device 102 and go to opportunities, and post for help.

At 606, the one who proposes work may be allow the user to fill in data requirements. The data requirements may comprise, request, date, states, time, properties to show, duration, address, client information, and so forth.

At 608, the one who proposes work may search for proposal in requests. The requests may be pending requests present on the one who has proposed the work.

At 610, the one who proposes work may choose agent from the list of applicants.

At 612, the one who does work may filter the agent by type of work.

At 614, the one who does work may open work details.

At 616, the one who does work may submit a proposal and the process move to 610 and then to 620

At 618, the one who does work may find a proposal in pending requests and the process end.

At 620, the one who proposes work may check if the agent is chosen or not. If the agent is chosen the process moves to 622, otherwise the process moves to 624.

At 622, the one who does work may delete request from the pending requests.

At 624, the one who does work may search for details.

At 626, the one who does work may create chat, and the chat is created the process is moved to step 628.

At 628, the one who does the work may press work done.

At 630, the one who does work may fill needed fields.

At 632, the one who proposes work may Confirm/Report Fraud.

At 634, the one who does work and the one who proposes work may provide feedback.

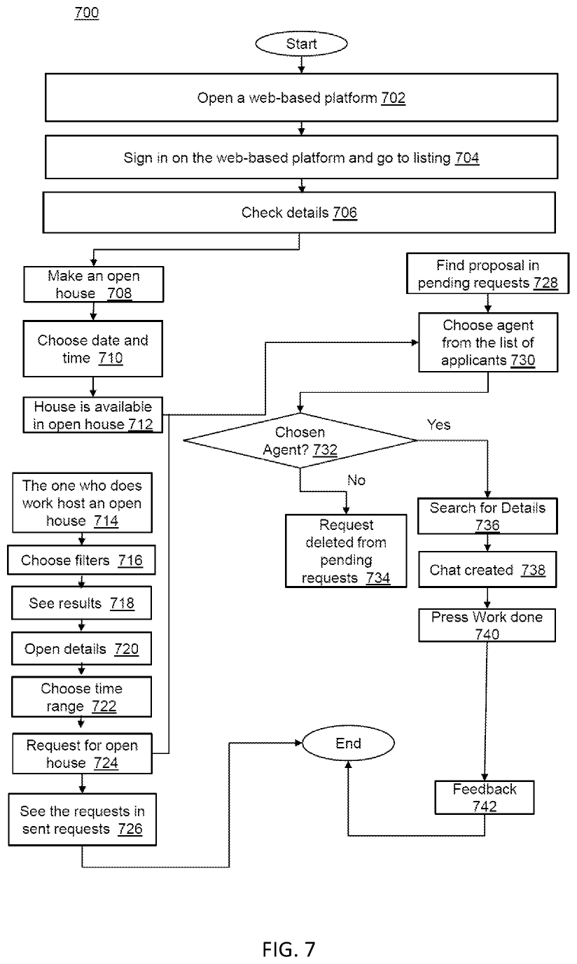

FIG. 7 illustrate a process flow 700 of the open house opportunities identification system 100, according to embodiments of the present invention.

At 702, the one who proposes work open up the web-based platform 108 installed on the user device 102.

At step 704, the one who proposes work may go to the listings using the web-based platform 108.

At step 706, the one who proposes work checks details of all the registered users.

At step 708, the one who proposes work makes an open house on the web-based platform 108.

At step 710, the one who proposes work chose date and time when a pop up appears.

At step 712, the one who proposes work may see a house available in open house.

At step 714, the one who does the work may host an open house.

At step 716, the one who does the work may choose filters. The filters may comprise, a state filter, a price filter, a date filter, and so forth.

At step 718, the one who does the work may see results.

At 720, the one who does the work may open details.

At 722, the one who does the work may choose time and range.

At 724, the one who does the work may request for open house.

At 726, the one who does the work may see the request in sent requests.

At 728, the one who proposes the work may find a proposal in pending requests.

At 730, the one who proposes the work may choose agent from the list of applicants.

At 732, the one who proposes the work may check if the agent is chosen or not. If the agent is chosen the process moves to 736, otherwise the process moves to step 734.

At 734, the one who does the work may delete request from the pending requests.

At 736, the one who does the work may search for details.

At 738, the one who does the work may create chat.

At 740, the one who does the work may press work done.

At 742, the one who does the work and the one who proposes the work may provide feedback.

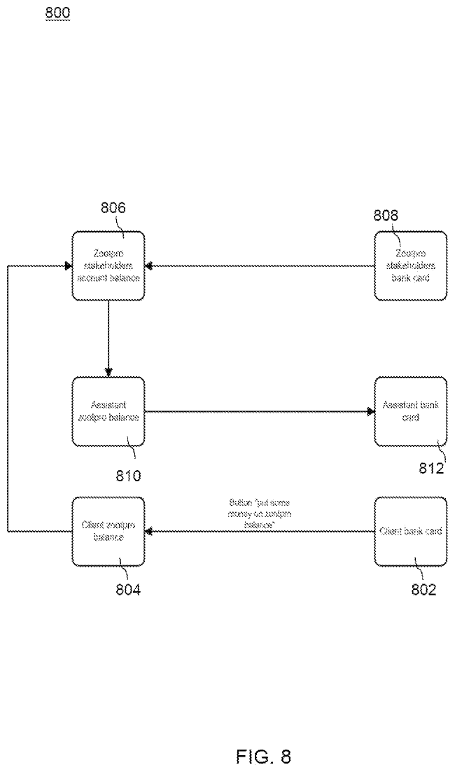

FIG. 8 illustrates a process flow 800 of the payment involved in the open house opportunities identification system 800, according to embodiments of the present invention. The client bank card 802 may be associated with the client zootpro balance, which further is associated with zootpro stakeholders account balance 806 linked with zootpro stakeholders bank card 808. In an embodiment of the present invention, zootpro stakeholders account balance 806 may be associated with assistant zootpro balance having an assistant bank card.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed is:

1. A method for allowing real estate agents to identify open house opportunities, the method comprising:
configuring, at least one user device for at least one user registration, the at least one user device communicably coupled with a communication network for creating a user account using a web-based platform installed on the at least one user device;
receiving, data associated with the at least one user on a storage arrangement when the registration is completed, data being processed by a processor component configured on the storage arrangement, wherein the processor component is configured to:
pull a plurality of active real estate listings from the storage arrangement for processing;
create a filter for demarcating and grouping licensed real estate agents based on brokerage affiliations, the filter is configured to break up the licensed real estate agents into pools associated with their brokerage affiliations;
assign each listing by brokerage to ensure that the filter remain in place and the licensed real estate agents view open houses within their specific brokerage;
identify the licensed real estate listing agents for each listing;
notify listing agents and prompts the listing agent to authenticate ownership of the listing;
match the plurality of active real estate listings to the listing agent using a unique identifier, when the listing agent is confirmed within the web-based platform installed on the at least one user device, the listing agent is allowed to make and schedule the listing available on selected dates and times for hosting an open house;
display the selected dates and times to the listing agents and a plurality of hosting agents affiliated within the same brokerage as the listing agent on a user interface of the at least one user device;
allow each of the hosting agents and the listing agents affiliated within the same brokerage as the listing agents to submit request for hosting an open house slot at the listing on behalf of the listing agent on selected dates and times; and
allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform installed on the at least one user device.

2. The method of claim 1, wherein data comprises open house details, agent hosting an open house, photographs, a name, a contact number, an email, a biography, hosting agent details, listing agent details, and/or foregoing combination.

3. The method of claim 1, wherein the filter comprises a “Chinese wall” barrier.

4. The method of claim 1, wherein the unique identifier being known as a Multiple Listing Service (MLS) ID number.

5. The method of claim 1, wherein the activities comprise showings, attending home inspections, attending walkthroughs and other tasks.

6. The method of claim 1, wherein each listing by brokerage being assigned based on a proprietary broker ID.

7. The method of claim 1, wherein the filter is configured to break up the licensed real estate agents into pools associated with their credentials.

8. The method of claim 1, wherein the pools formed of the licensed real estate agents being further utilized to create an intra-broker pool of licensed real estate agents to facilitate showings on a dynamic calendar.

9. The method of claim 8, wherein when the intra-broker is available, the intra-broker pool being matched to a plurality of parameters.

10. The method of claim 9, wherein the plurality of parameters comprises geographic location, a state license possession, availability, and/or any foregoing combination.

11. The method of claim 1, wherein the licensed real estate agents identified within a broker have no visibility or contact ability to licensed real estate agents that are members of a competing brokerage.

12. The method of claim 1, wherein the listing agents are notified through notifications sent to the listing agents based on availability and proximity to a showing.

13. The method of claim 1, further comprising accessing and scheduling open house opportunities for creating a compensation mechanism using the processor component between a buyer or the licensed real estate agent posting the open house opportunities and the licensed real estate agent hosting the open house opportunities.

14. An open house opportunities identification system, the system comprising:
at least one user device configured for at least one user registration;
a communication network configured to communicate with the at least one user device for creating a user account using a web-based platform installed on the at least one user device;
a storage arrangement configured to receive data associated with the at least one user, when the registration of the at least one user is completed;
a processor component configured on the storage arrangement for processing the data, wherein the processor component is configured to:
pull a plurality of active real estate listings from the storage arrangement for processing;
create a filter for demarcating licensed real estate agents based on brokerage affiliations the filter is configured to break up the licensed real estate agents into pools associated with their brokerage affiliations;
assign each listing by brokerage to ensure that the filter remain in place and the licensed real estate agents view open houses within their specific brokerage;
identify the licensed real estate agents for each listing, the licensed real estate agents identified within a broker have no visibility or contact ability to licensed real estate agents that are members of a competing brokerage;
notify listing agents and prompts the listing agent to authenticate ownership of the listing;
match the plurality of active real estate listings to the listing agent using a unique identifier, when the listing agent is confirmed within the web-based platform installed on the at least one user device, the listing agent is allowed to make the listing available on selected dates and times for hosting an open house;
display the selected dates and times to the listing agents and a plurality of hosting agents affiliated within the same brokerage as the listing agent on a user interface of the at least one user device;
allow each of the hosting agents and the listing agents affiliated within the same brokerage as the listing agents to submit request for hosting an open house slot at the listing on behalf of the listing agent on selected dates and times; and
allow the licensed real estate agents to hire other licensed real estate agents based on calendar availability or location to host each open house slot and complete licensed real estate activities, when one of the licensed real estate agents is selected, each brokerage is allowed to publish a list of the open houses and data of the hosting agent hosting the open house to the public through the web-based platform installed on the at least one user device.

15. The system of claim 14, wherein the pools formed of the licensed real estate agents being further utilized to create an intra-broker pool of licensed real estate agents to facilitate showings on a dynamic calendar.

16. The system of claim 15, wherein when the intra-broker is available, the intra-broker pool being matched to a plurality of parameters.

17. The system of claim 16, wherein the plurality of parameters comprises geographic location, a state license possession, availability, and/or any foregoing combination.

18. The system of claim 14, wherein the listing agents are notified through notifications sent to the listing agents based on availability and proximity to a showing.

19. The system of claim 14, wherein data comprises open house details, agent hosting an open house, photographs, a name, a contact number, an email, hosting agent details, listing agent details, and/or foregoing combination.

20. The system of claim 14, wherein each listing by brokerage being assigned based on a proprietary broker ID.
